(19) United States
(12) Patent Application Publication
(10) Pub. No.: US 2026/0178339 A1
(43) Pub. Date: Jun. 25, 2026

(54) CO-ISSUE OF INSTRUCTIONS IN MULTI-CHIPLET PROCESSORS

(71) Applicant: Advanced Micro Devices, Inc., Santa Clara, CA (US)

(72) Inventors: Bin He, Orlando, FL (US); Subramaniam Maiyuran, Folsom, CA (US); Brian Emberling, Santa Clara, CA (US); Michael Mantor, Orlando, FL (US); Ryan J. Cash, Orlando, FL (US); Xiaoxiao Liu, Santa Clara, CA (US); Chandra Sekhar Gurram, Folsom, CA (US)

(21) Appl. No.: 18/999,314

(22) Filed: Dec. 23, 2024

(51) Int. Cl. G06F 9/38; G06F 9/30

(52) U.S. Cl. CPC G06F 9/3887; G06F 9/30014; G06F 9/3836

(57) ABSTRACT

Systems and techniques for providing co-issue of instructions utilize a scheduler associated with a compute unit to select one double-precision (i.e., 64-bit) instruction and one single-precision (i.e., 32-bit) instruction for issue to and execution at a compute unit. Each compute unit includes or is associated with one or more pairs of double-precision arithmetic logic units (ALUs) and single-precision ALUs. The selected double-precision and single-precision instructions are associated with different threads or waves such that no dependency can exist between the two instructions. The selected single-precision instruction may perform address calculations or other memory tasks while the double-precision instruction may perform data computations that may be required for, e.g., matrix multiplication, or other machine learning functionality.

### BACKGROUND

Parallel processors such as accelerator processors and graphics processing units (GPUs) conventionally implement graphics processing pipelines that concurrently process copies of commands that are retrieved from a command buffer. GPUs and other multithreaded processing units typically implement multiple processing elements (which may include processor cores, compute units, chiplets, or workgroup processors) that execute different programs or concurrently execute multiple instances of a single program on multiple data sets as a single “wave,” i.e., a group of threads running concurrently on a GPU. A hierarchical execution model is typically used to match the hierarchy implemented in hardware.

The execution model defines a kernel of instructions that are executed by one or more waves (also referred to as wavefronts, which may include one or more threads, streams, tasks, or work items). The graphics pipeline in a conventional GPU includes one or more shader engines that execute computer programs typically referred to as “shaders” using resources of the graphics pipeline such as compute units, memory, and caches. GPUs are traditionally used for graphical calculations, as implied by their name; however, in modern computing, shaders are often utilized as “compute shaders,” which function as general-purpose software that is able to perform work separately from a graphics processing pipeline. As GPU usage and machine learning applications have expanded over time, there is a necessity to improve the functionality and performance of GPUs.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system providing co-issue of instructions in a multi-chiplet processor according to some implementations.

FIG. 2 is a block diagram illustrating an example of co-issue of instructions in a multi-chiplet processor according to some implementations.

FIG. 3 is a flow diagram of a method of co-issuing instructions in multi-chiplet processors according to some implementations.

### DETAILED DESCRIPTION

A parallel processor such as an accelerated processing device or graphics processing unit (GPU) typically includes a plurality of “shader engines,” where each shader engine includes a respective quantity of compute units, and a command processor (CP) coupled to the plurality of shader engines. The CP receives one or more commands for execution and generates the plurality of workgroups or tasks (e.g., processing threads or collections of threads corresponding to one or more programs) based on the one or more commands. Assigning each workgroup to a respective shader engine may include dynamically assigning each workgroup to a respective shader engine via an interface such as a shader program interface, which acts as a scheduler, associated with the respective shader engine.

As GPU usage for executing compute shaders, machine learning applications, and other general-purpose applications has expanded over time, in order to provide a GPU with the flexibility to execute tasks related to a graphics processing pipeline, machine learning, or other advanced computing applications in an efficient manner, GPUs implemented in accordance with the teachings of the present disclosure include a plurality of parallel processing chiplets (PPCs). In some implementations, the PPCs are configured to process tasks and function as advanced GPU chiplets in that they offer one or more of parallel processing functionality, optimized GPU functionality, and optimized processing for advanced applications that utilize, e.g., reduced precision data common in machine learning. The PPCs are able to execute instructions separately or in parallel and, in some implementations, share a single pool of virtual and physical memory with extremely low latency.

Modern processors are designed to handle multiple instructions simultaneously through techniques like pipelining, parallelism, and multi-threading. However, individual compute units within processors can typically only handle a single instruction at a time, which can limit the efficiency and speed at which tasks can be executed. When only a single instruction is issued at a time to each compute unit of a processor, resources of the compute unit may be underutilized, as there may be dependencies that prevent the instruction from executing immediately. This bottleneck can increase the amount of time sets of instructions take to execute, reduce overall throughput, and decrease the efficiency of performing complex or large-scale tasks, particularly for data-intensive operations such as matrix multiplication.

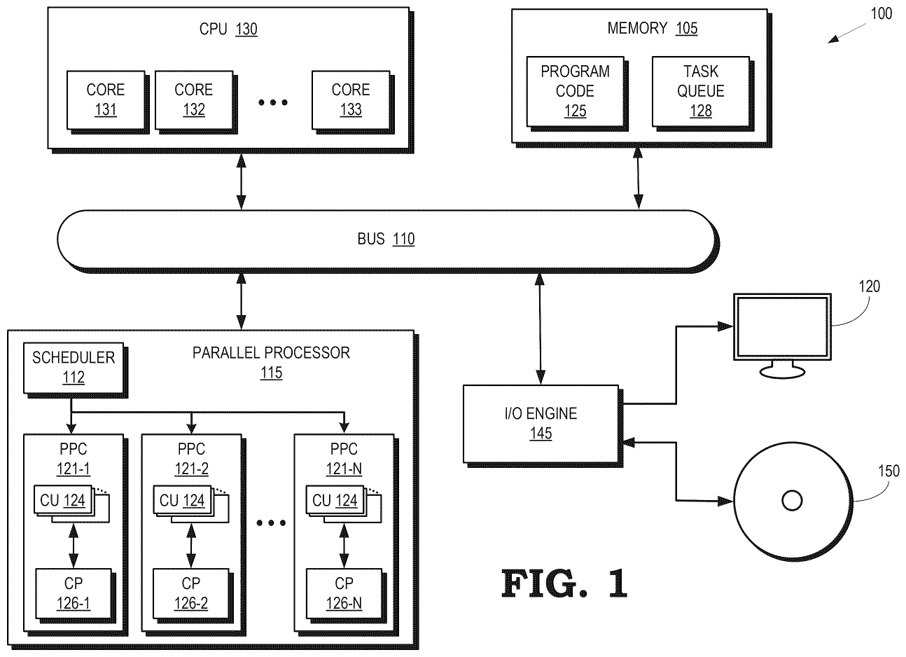

FIGS. 1-3 illustrate systems and techniques for “co-issuing” or simultaneously issuing and executing multiple instructions at a single compute unit of a processor. For example, in some implementations, a scheduler or sequencer associated with a compute unit selects one double-precision (i.e., 64-bit) instruction and one single-precision (i.e., 32-bit) instruction for issue to and execution at a compute unit. In some implementations, each compute unit includes or is associated with one or more double-precision arithmetic logic units (ALUs) and one or more single-precision ALUs. By selecting one double-precision instruction and one single-precision instruction for execution at each compute unit, in some implementations, memory bandwidth and processor throughput are maximized.

In some implementations, the selected double-precision and single-precision instructions are associated with different threads or waves such that no dependency can exist between the two instructions, eliminating the need to consider data hazards in their selection. For example, the selected single-precision instruction may perform address calculations or other memory tasks while the double-precision instruction may perform data computations that may be required for, e.g., matrix multiplication, or other machine learning functionality. Selecting instructions from different waves also ensures that if one of the waves does get stalled or interrupted by a data hazard or other dependency, the other wave may still be able to be executed by its assigned compute unit, maximizing processor throughput and ALU usage. Overall, co-issuing different types of instructions from different waves to individual compute units helps to improve performance with little added cost. In some implementations, a first instruction from an oldest wave and a second instruction from a second-oldest wave are selected for execution.

FIG. 1 is a block diagram of a processing system 100 providing co-issue of instructions to a compute unit of a processor for concurrent execution according to some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The techniques described herein are, in different implementations, employed at any of a variety of parallel processors (e.g., vector processors, GPUs, general-purpose GPUs (GPGPUs), non-scalar processors, highly parallel processors, artificial intelligence (AI) processors, inference engines, machine learning processors, other multithreaded processing units, and the like). FIG. 1 illustrates an example of a parallel processor 115, which is implemented in the illustrated example as a multi-chiplet processor, in accordance with some implementations. In some implementations, the parallel processor 115 renders images for presentation on a display 120. For example, the parallel processor 115 renders objects to produce values of pixels that are provided to the display 120, which uses the pixel values to display an image that represents the rendered objects. However, the parallel processor 115 is also capable of executing software not directly involved in any graphics processing pipeline, such as machine learning applications and other advanced computing applications.

In order to provide the parallel processor 115 with the flexibility to execute tasks related to a graphics processing pipeline, machine learning, or other advanced computing applications in an efficient manner, the parallel processor 115 includes a plurality of PPCs, such as PPCs 121-1, 121-2, and 121-N, which are configured to process tasks and offer one or more of GPU functionality and optimized processing for advanced applications that utilize, e.g., reduced precision data common in machine learning. By providing the parallel processor 115 with a plurality of PPCs 121, the parallel processor 115 is able to perform a number of tasks simultaneously while latency and data transfer energy between the PPCs 121 is minimized. The PPCs 121 are typically implemented using shared hardware resources of the parallel processor 115, such as compute units 124. In some implementations, the PPCs 121 are used to implement shaders, such as geometry shaders, pixel shaders, and the like. Generally, the PPCs 121 are a logical grouping of processing hardware, which in some implementations includes, e.g., one or more processing chiplets, cores, and/or caches. The PPCs 121 typically include or access a number of compute units 124 in the parallel processor 115, and each of the compute units 124 typically includes a number of single-instruction-multiple-data (SIMD) units. The number of PPCs 121 implemented in the parallel processor 115 is a matter of design choice and some implementations of the parallel processor 115 include more or fewer PPCs than are shown in FIG. 1.

In some implementations, the processing system 100 also includes a CPU 130 that is connected to the bus 110 through which it communicates with the parallel processor 115 and the memory 105. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some implementations include more or fewer processor cores than are illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics or other processing by issuing draw calls or other tasks to the parallel processor 115.

In some implementations, as shown in the example of FIG. 1, the PPCs 121 each include a CP 126, such as CPs 126-1, 126-2, and 126-N, to manage and facilitate execution of incoming instructions or tasks. Tasks are stored in a task queue 128 in the memory 105, which also stores dependency information related to the tasks. In some implementations, the task queue 128 is duplicated or instead stored in the parallel processor 115 and/or CPU 130. Generally, the task queue 128 is stored in a location accessible by the CPU 130 and the parallel processor 115 so that the status of the tasks and dependency information in the task queue 128 can be monitored and new tasks and dependency information can be added as needed by, e.g., the CPU 130 or the parallel processor 115. In some implementations, the task queue 128 is implemented as a circular buffer with associated read and write pointers, but in other implementations the task queue 128 takes other forms such as an ordered list or cache.

As shown in FIG. 1, the parallel processor 115 further includes a scheduler 112, sometimes referred to as a sequencer, which is implemented as any cooperating collection of hardware, software, or a combination thereof that performs functions and computations associated with assigning threads, workgroups, waves, or other tasks, such as compute shader threads, to one or more of the PPCs 121. In some implementations, one or more schedulers or sequencers are incorporated into one or more PPCs, compute units 124, and/or CPs 126. In some implementations, one or more of the PPCs 121 are able to be selectively addressed or controlled independently from one another or addressed or controlled in groups of two or more such that the parallel processor 115, the scheduler 112, and/or a user is able to control which PPCs 121 perform specific tasks or to distribute tasks across a number of PPCs 121. In some implementations, the parallel processor 115 is used for general purpose computing. The parallel processor 115 executes instructions such as program code 125 stored in the memory 105 based on dependency information stored in the task queue 128, and the parallel processor 115 stores information in the memory 105 such as the results of the executed instructions, new dependency information for tasks, and indications that dependencies have been satisfied, e.g., when tasks associated with dependency information have finished executing.

In some implementations, the scheduler 112 and the CPs 126 work together or in parallel to process tasks and dependency information from the task queue 128. For example, in some implementations, the scheduler 112 assigns tasks to the compute units 124, and the compute units 124 interface with the task queue 128 to determine when tasks can be executed out of order based on dependency information specified in the task queue 128. In some implementations, the scheduler 112 interfaces with the task queue 128 to determine which tasks to assign to the compute units 124 based on the dependency information. Accordingly, in some implementations, the scheduler 112 and compute units 124 work together to ensure maximum parallelization and optimized throughput of task execution in the parallel processor 115.

In some implementations, at least one of the PPCs 121, compute units 124, and/or CPs 126 includes hardware configured to co-issue and/or co-execute instructions. For example, in some implementations, the scheduler 112 (or sequencer) selects a first task from a wave utilizing 64-bit instructions and a second task from a wave utilizing 32-bit instructions. The scheduler 112 then simultaneously assigns or “co-issues” the first and second tasks to a PPC 121, one of the compute units 124, and/or one of the CPs 126. Subsequently, the first and second instructions are respectively assigned to 64-bit and 32-bit ALUs contained in the PPC 121 and/or one of the compute units 124 for co-execution. By utilizing separate ALUs configured for different instruction sizes, the PPC 121 and/or compute units 124 are able to maximize processing throughput and memory bandwidth by continuing to execute one or the other of the first and second instructions even when a data hazard or other dependency prevents one of the first and second instructions from being immediately executed.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the parallel processor 115, or the CPU 130. In the illustrated implementation, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the parallel processor 115 or the CPU 130.

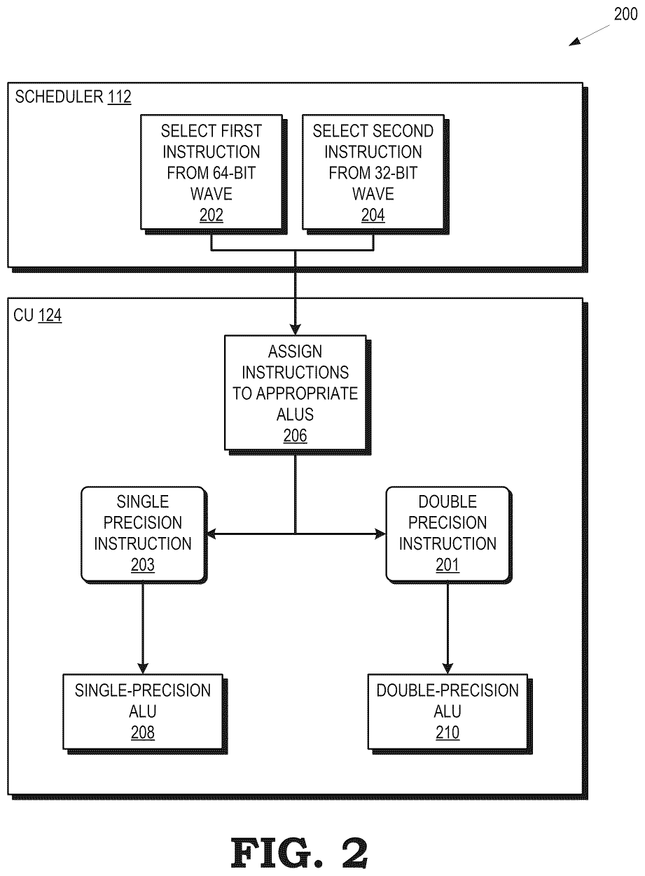

FIG. 2 is a block diagram illustrating an example 200 of co-issue of instructions in a multi-chiplet processor according to some implementations. As shown in FIG. 2, in some implementations, at least one of the parallel processor 115, the PPCs 121, and the compute units 124 of the system 100 of FIG. 1 are configured to simultaneously execute a double-precision (64-bit) instruction 201 received or retrieved from memory at block 202 and a single-precision (32-bit) instruction 203 received or retrieved from memory at block 204 (e.g., by the scheduler 112) by assigning a plurality of instructions having different bit-widths to different ALUs. At block 206, the single-precision instruction 203 is assigned to a single-precision ALU 208 and the double-precision instruction 201 is assigned to a double-precision ALU 210, e.g., by the compute unit 124. As shown in FIG. 2, in some implementations, the parallel processor 115, the PPCs 121, and/or the compute units 124 include at least pair of a double-precision ALU and a single-precision ALU.

By selecting the double-precision instruction and the single-precision instruction to be issued to the compute unit via, e.g., the scheduler 112 and/or a sequencer embedded in each PPC 121, compute unit 124, and/or CP 126, the double-precision and single-precision ALUs and associated memories are used more efficiently, which in some implementations helps to maximize usage of memory bandwidth and processor throughput. In some implementations, the double-precision instruction is associated with a first wave (i.e., set of instructions) and the single-precision instruction is associated with a second wave independent from the first wave. For example, in some implementations, the double-precision instruction is an instruction to perform data computations associated with matrix multiplication while the single-precision instruction is an instruction to perform an address calculation or memory task. In other implementations, a first instruction, such as a double-precision instruction, is associated with a first wave or set of instructions and a second instruction, such as a single-precision instruction, is associated with a second wave or set of instructions, where the first wave and the second wave are the oldest waves to be executed, i.e., the threads or tasks that have been awaiting execution the longest.

In some implementations, by incorporating or associating a pair of a double-precision ALU and a single-precision ALU in each PPC 121 or compute unit 124, execution of instructions is able to continue when a single one of the double-precision instruction and the single-precision instruction is stalled or interrupted. The PPC 121 and/or compute unit 124 are thus able to continue to perform operations when otherwise the PPC 121 and/or compute unit 124 may temporarily cease to function (e.g., when a compute unit 124 includes only one type of ALU and an instruction using that ALU gets stalled or interrupted) and lead to reductions in performance.

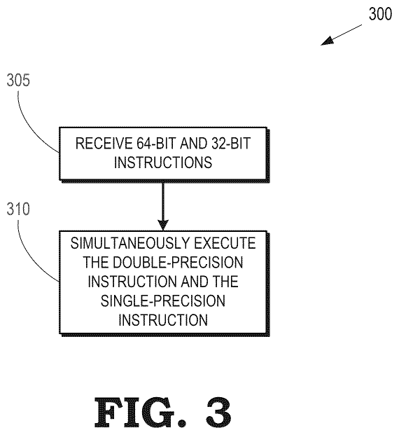

FIG. 3 is a flow diagram of a method 300 of co-issuing instructions in multi-chiplet processors, such as the parallel processor 115 of FIG. 1 including a plurality of PPCs 121, according to some implementations. In some implementations, the method 300 is executed by at least one of the PPCs 121, compute units 124, and/or CPs 126 of the system 100 of FIG. 1. At block 305 of the method 300, a double-precision (64-bit) instruction and a single-precision (32-bit) instruction are received or retrieved from memory. At block 310, the PPCs 121, compute units 124, and/or CPs 126 simultaneously issue and/or execute, e.g., at one of the compute units 124, the double-precision instruction and the single-precision instruction, e.g., using a pair of a single-precision ALU 208 and a double-precision ALU 210 like those of FIG. 2.

In some implementations, the method 300 includes selecting, at a scheduler associated with the compute unit, the double-precision instruction and the single-precision instruction to be issued to the compute unit. In some implementations, the double-precision instruction is associated with a first wave or set of instructions and the single-precision instruction is associated with a second wave or set of instructions, wherein the second wave is independent from the first wave. In some implementations, the double-precision instruction is an instruction to perform data computations associated with matrix multiplication. In some implementations, the single-precision instruction is an instruction to perform an address calculation or memory task. In some implementations, the method 300 continues execution of instructions when a single one of the double-precision instruction and the single-precision instruction is stalled or interrupted. In some implementations, the double-precision instruction is associated with a first wave or set of instructions and the single-precision instruction is associated with a second wave or set of instructions, wherein the first wave and the second wave are the oldest waves to be executed.

In some implementations, the apparatuses and techniques described above are implemented in a system including one or more integrated circuit (IC) devices (also referred to as integrated circuit packages or microchips), such as the parallel processor 115, the PPCs 121, the compute units 124, the CPs 126, and the methods 200 and 300 described above. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An apparatus comprising:
a parallel processor, wherein:
a compute unit of the parallel processor is configured to execute a double-precision (64-bit) instruction while executing a single-precision (32-bit) instruction.

2. The apparatus of claim 1, wherein the compute unit includes at least one double-precision arithmetic logic unit (ALU) and at least one single-precision ALU.

3. The apparatus of claim 1, further comprising a scheduler configured to select the double-precision instruction and the single-precision instruction to be issued to the compute unit.

4. The apparatus of claim 3, wherein the double-precision instruction is associated with a first set of instructions and the single-precision instruction is associated with a second set of instructions, wherein the second set of instructions is independent from the first set of instructions.

5. The apparatus of claim 3, wherein the double-precision instruction is an instruction to perform a data computation associated with matrix multiplication.

6. The apparatus of claim 3, wherein the single-precision instruction is an instruction to perform at least one of an address calculation and a memory task.

7. The apparatus of claim 1, wherein the compute unit is configured to continue execution of instructions when a single one of the double-precision instruction and the single-precision instruction is stalled.

8. The apparatus of claim 1, wherein the double-precision instruction is associated with a first set of instructions and the single-precision instruction is associated with a second set of instructions, wherein the first set of instructions and the second set of instructions are older than any other set of instructions ready to be executed.

9. A method, comprising:
receiving a double-precision (64-bit) instruction and a single-precision (32-bit) instruction; and
executing, at a compute unit of a parallel processing chiplet, the double-precision instruction while executing the single-precision instruction.

10. The method of claim 9, wherein the compute unit includes at least one double-precision arithmetic logic unit (ALU) and at least one single-precision ALU.

11. The method of claim 9, further comprising selecting, at a scheduler associated with the compute unit, the double-precision instruction and the single-precision instruction to be issued to the compute unit.

12. The method of claim 11, wherein the double-precision instruction is associated with a first set of instructions and the single-precision instruction is associated with a second set of instructions, wherein the second set of instructions is independent from the first set of instructions.

13. The method of claim 11, wherein the double-precision instruction is an instruction to perform a data computation associated with matrix multiplication.

14. The method of claim 11, wherein the single-precision instruction is an instruction to perform at least one of an address calculation and a memory task.

15. The method of claim 9, further comprising continuing execution of instructions when a single one of the double-precision instruction and the single-precision instruction is stalled.

16. The method of claim 15, wherein the double-precision instruction is associated with a first set of instructions and the single-precision instruction is associated with a second set of instructions, wherein the first set of instructions and the second set of instructions are older than any other set of instructions ready to be executed.

17. A system comprising:
a memory configured to store a double-precision (64-bit) instruction and a single-precision (32-bit) instruction; and
a compute unit configured to execute a double-precision (64-bit) instruction while executing a single-precision (32-bit) instruction.

18. The system of claim 17, wherein the compute unit includes at least one double-precision arithmetic logic unit (ALU) and at least one single-precision ALU.

19. The system of claim 17, wherein the double-precision instruction is associated with a first set of instructions and the single-precision instruction is associated with a second set of instructions, wherein the second set of instructions is independent from the first set of instructions.

20. The system of claim 17, wherein the compute unit is configured to continue execution of instructions when a single one of the double-precision instruction and the single-precision instruction is stalled.
